(19) United States
(12) Patent Application Publication
(10) Pub. No.: US 2026/0003070 A1
(43) Pub. Date: Jan. 1, 2026

(54) DRY-BULK STOCKPILE MONITORING

(71) Applicant: ICEYE OY, Espoo (FI)

(72) Inventors: Ibrahim El Merehbi, Espoo (FI); Valentyn Tolpekin, Espoo (FI); Chrisoffer Winquist, Espoo (FI); Michael Wollersheim, Espoo (FI); Duhane Lam, Espoo (FI)

(21) Appl. No.: 19/115,689

(22) PCT Filed: Aug. 15, 2023
(86) PCT No.: PCT/EP2023/072486

§ 371 Date: Mar. 26, 2025

(30) Foreign Application Priority Data
Aug. 31, 2022 (GB) 2212689.0

(51) Int. Cl. G01S 13/90; G06T 7/00; G06T 7/593; G06T 7/62

(52) U.S. Cl. CPC G01S 13/9023; G06T 7/0002; G06T 7/593; G06T 7/62; G06T 2207/10012; G06T 2207/10028; G06T 2207/10044; G06T 2207/30188

(57) ABSTRACT

There is provided a method of monitoring a dry-bulk stockpile, the method comprising: receiving first image data collected by a satellite in orbit around the Earth. The first image data corresponds to a synthetic aperture radar image of a first area that includes the dry-bulk stockpile. The method further comprises receiving second image data collected by a satellite in orbit around the Earth. The second image data corresponds to a synthetic aperture radar image of a second area that includes the dry-bulk stockpile. The method further comprises determining whether the first and second image data were collected by one or two satellites on different orbits around the Earth or by one or two satellites on the same orbit around the Earth. If the first and second image data were collected by two satellites on different orbits, the method further comprises applying radargrammetric analysis to the first and second image data to determine one or more properties of the dry-bulk stockpile based on the radargrammetric analysis. If the first and second image data were collected by one or two satellites on the same orbit around the Earth, the method further comprises applying interferometric analysis to the first and second image data to determine one or more properties of the dry-bulk stockpile.

### TECHNICAL FIELD

The present application relates to methods and systems for monitoring and/or measuring properties of dry-bulk material stockpiles. In particular, the present invention relates to methods and systems for monitoring and/or measuring the volume of bulk material stockpiles using satellite imaging techniques.

### BACKGROUND

Dry-bulk materials including, amongst others, iron ore, coal, grains, sugar, and cocoa are traded across the world. For example, dry-bulk materials such as iron ore and coal are mined and then shipped internationally from sea ports. These sea ports, operating as export hubs, store the materials in port areas that are often specifically designated for a particular dry-bulk material stockpile until they are ready for transportation. These stockpiles may vary in size, for example typical stockpiles may have a substantially conical or mound-like shape with a height typically in the range between 0.5 metres and 40 metres, and with a base diameter typically in the range between 0.5 metres to 100 metres. It is useful to monitor the volume, and changes in volume, of dry-bulk stockpiles for the purposes of stock control and also for safety reasons as large stockpiles can become highly unstable above a critical mass/volume. This instability could have catastrophic consequences if the stockpile collapses as the resultant slide of material can represent a significant danger to life.

Typical methods of monitoring the volume of dry-bulk stockpiles involve measurement of the stockpile on-site. This requires access to the site and, as mentioned above, in the case of large or unstable stockpiles could represent a serious danger to those visiting the site to carry out measurements. Alternative methods involve determining volumes of stockpiles based on images taken by aircraft, for example unmanned aerial vehicles (UAVs), flying over the stockpiles. However, these methods rely on access to the airspace in the vicinity of the stockpiles which may not be possible, particularly if the stockpiles are stored in the vicinity of major transportation hubs such as ports and airports, where airspace access may be restricted.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter; variants and alternative features which facilitate the working of the claimed subject matter and/or serve to achieve a substantially similar technical effect should be considered as falling into the scope of the claims.

The invention is defined as set out in the appended set of claims.

In a first aspect, there is provided a method of monitoring a dry-bulk stockpile, the method comprising: receiving first image data collected by a first satellite in orbit around the Earth. The first image data corresponds to a synthetic aperture radar image of a first area that includes the dry-bulk stockpile. The method further comprises receiving second image data collected by a second satellite in orbit around the Earth. The second image data corresponds to a synthetic aperture radar image of a second area that includes the dry-bulk stockpile. The first and second satellites are orbiting around the Earth along different orbits. The method further comprises applying radargrammetric analysis to the first and second image data to determine one or more properties of the dry-bulk stockpile based on the radargrammetric analysis.

By basing the monitoring of the dry-bulk stockpile on satellite imagery, issues related to physically accessing the site of the dry-bulk stockpile, or the airspace in the vicinity of the stockpile are entirely negated. Additionally, basing the monitoring on synthetic aperture radar (SAR) images allows the method to be carried out regardless of the weather conditions in the area containing the stockpile—satellite photo-imaging would not, for example, be able to penetrate cloud cover between the stockpile and the satellites. In contrast, clouds and other weather systems are transparent to radar signals and so by basing the monitoring on SAR imaging, the method is made significantly more versatile than would otherwise be possible.

As will be discussed below, satellite radargrammetry is a flexible imaging technique that may be applied when the two satellites collecting the first and second image data are in different orbits across a wide range of possible geometries. This makes the methods described herein particularly versatile across a wide range of imaging conditions.

In a further aspect, there is provided a method of monitoring a dry-bulk stockpile, the method comprising: receiving first image data collected by a satellite in orbit around the Earth. The first image data corresponds to a synthetic aperture radar image of a first area that includes the dry-bulk stockpile. The method further comprises receiving second image data collected by a satellite in orbit around the Earth. The second image data corresponds to a synthetic aperture radar image of a second area that includes the dry-bulk stockpile. The method further comprises determining whether the first and second image data were collected by two satellites on different orbits around the Earth or by one or two satellites on the same orbit around the Earth. If the first and second image data were collected by two satellites on different orbits, the method further comprises applying radargrammetric analysis to the first and second image data to determine one or more properties of the dry-bulk stockpile based on the radargrammetric analysis. If the first and second image data were collected by one or two satellites on the same orbit around the Earth, the method further comprises applying interferometric analysis to the first and second image data to determine one or more properties of the dry-bulk stockpile.

This method may leverage the same advantages as the method described above, but with additional versatility arising from the use of interferometric synthetic aperture radar (InSAR) imaging when the two images are taken by a satellite (or satellites) in a single orbit around the Earth. Satellite-based InSAR imaging is useable to generate elevation models with high levels of accuracy: accurate on a scale of centimetres to decimetres.

In a further aspect, there is provided a data processing apparatus comprising a processor configure to perform the methods described herein.

In a further aspect, there is provided a computer program comprising instructions that, when the program is executed by a computer, cause the computer to carry out the methods described herein.

In a further aspect, there is provided a computer-readable medium comprising logic that, when executed by a computer, cause the computer to carry out the methods described herein.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is issued for designing silicon chips, or for configuring universal programmable chips, to carry out desired functions.

The features and embodiments discussed herein may be combined as appropriate, as would be apparent to a person skilled in the art, and may be combined with any of the aspects except where it is expressly provided that such a combination is not possible or the person skilled in the art would understand that such a combination is self-evidently not possible.

### BRIEF DESCRIPTION OF THE DRAWINGS

Embodiments of the present invention are described below, by way of example, with reference to the following drawings.

FIG. 1 depicts an exemplary satellite in orbit around the Earth.

FIG. 2a is a schematic showing two satellites in orbit around the Earth, collecting an image of a dry-bulk stockpile with the imaging areas of the two satellites intersecting in a same-side imaging configuration.

FIG. 2b is a schematic showing an alternative view of FIG. 2a.

FIG. 3 is a schematic depicting the parallax (intersection) angle of the two satellites in FIGS. 2a-b.

FIG. 4a is a schematic showing two satellites in orbit around the Earth, collecting an image of a dry-bulk stockpile with the imaging areas of the two satellites intersecting in an opposite-side imaging configuration.

FIG. 4b is a schematic showing an alternative view of FIG. 4a.

FIG. 5 is a schematic depicting the parallax (intersection) angle of the two satellites in FIGS. 4a-b.

FIG. 6 shows an example synthetic aperture radar (SAR) image of an exemplary port area with dry-bulk stockpiles.

FIG. 7 is a flowchart of a method of monitoring and estimating the volume of a dry-bulk stockpile based on radargrammetry analysis.

FIG. 8 is a flowchart of a method of monitoring and estimating the volume of a dry-bulk stockpile based on interferometric analysis.

FIG. 9 shows an example of an SAR image produced according to the method shown in FIG. 8.

FIG. 10 is a flowchart of a method of monitoring and estimating the volume of a dry-bulk stockpile, wherein interferometric or radargrammetric analysis is selected based on the imaging conditions under which the dry-bulk stockpile is imaged.

FIG. 11 shows an example of a profile line sampled from a digital elevation model of a dry-bulk stockpile of a kind that may be produced according to the methods described herein.

FIG. 12 shows a schematic of a computer comprising a processor configured to implement the methods described herein.

Common reference numerals are used throughout the figures to indicate the same or similar features.

### DETAILED DESCRIPTION

Embodiments of the present invention are described below by way of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

In the following, systems and methods are described, some of which require multiple satellites and some of which require only one satellite. In systems where multiple satellites are used, the repeat cycle time for image acquisition—i.e., the time between consecutive images being taken by overhead satellites—may be shorter than would be achievable with a single satellite. In some of the examples discussed below, the repeat cycle time may be 48 hours or less, 24 hours or less, 12 hours or less, 6 hours or less, or 1 hour or less.

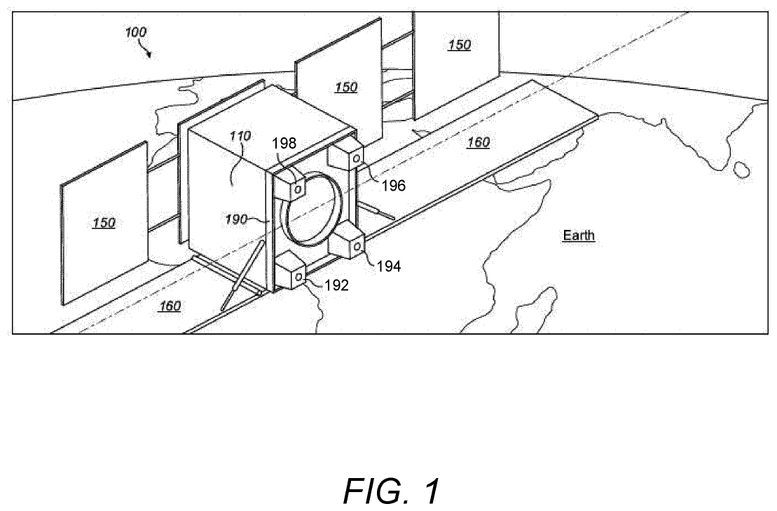

FIG. 1 depicts an exemplary satellite 100 in orbit around the Earth of the kind which may be used in the implementation of the systems and methods described here. The satellite of FIG. 1 comprises a body 110 which may be referred to in the art as a “bus” since it may house or support so-called bus components of a satellite. Body 110 may additionally house one or more batteries. Body 110 may be partially enclosed, for example to house and protect components. A housing may provide surfaces on which components may be mounted. In the example of FIG. 1, a solar panel 150 is mounted on one rectangular surface of the body 110 and additional solar panels may be attached to panel 150 by struts.

The satellite 100 comprises a generally planar structure extending from the body 110 in two opposing directions to provide two “wings” 160. The structure comprising wings 160 is shown to be mounted on or adjacent to a rectangular surface of the body 110. In an example, satellite 100 is an Earth observation satellite for imaging and monitoring the Earth using synthetic aperture radar. In this example, wings 160 form the antenna for the synthetic aperture radar. The wings 160 along with the solar panels 150 can be formed in sections so as to be folded for transport and unfolded when the satellite is deployed in space.

The satellite 100 is provided with a propulsion system 190 for manoeuvring the satellite with a generated thrust. The propulsion system 190 comprises a plurality of thrusters 192, 194, 196, 198 that produce thrust for manoeuvring the satellite 100 when required, for example to position the satellite into a different orbital track. The plurality of thrusters 192, 194, 196, 198 shown in FIG. 1 are positioned at the corners of one side of the body 110 and may be equally spaced apart. However, in some embodiments, the propulsion system 190 may have a different configuration.

In some examples, the satellite may be a micro-satellite or a small satellite. The smaller size and greater agility of micro-and small satellites may provide advantages for dry-bulk stockpile monitoring. In particular, micro-and small satellites are more agile and their orientation and orbital paths can be changed more easily in response to instructions to image a particular location on Earth and from a particular angle. In addition, smaller satellites can be significantly less expensive to manufacture and launch than traditional larger satellites. More of them can be launched for the same cost as a single larger satellite in order to form a constellation of satellites that can provide much more frequent revisit times compared to a single satellite, as described above. In some examples, the satellites can be deployed in constellation of five satellites or more, ten satellites or more, or twenty satellites or more.

In an example, satellite 100 may be a micro-satellite with a mass of approximately 100 kilograms. Traditional larger satellites may have a mass of approximately 1000 kilograms and are generally more expensive and less agile than micro- or small satellites. Satellites may, in some examples, be categorised according to their mass. For example, a satellite having a mass between approximately 1 kilogram and approximately 10 kilograms may be categorised as a cube satellite; a satellite having a mass between approximately 50 kilograms and approximately 250 kilograms may be categorised as a micro-satellite; and satellite having a mass of approximately 500 kilograms may be categorised as a small satellite; and a satellite having a mass between approximately 800 kilograms and approximately 1200 kilograms may be categorised as a regular satellite.

In an example, the satellite 100 may be orbiting Earth in a low-earth orbit. A low-earth orbit may have an altitude between 160 kilometres and 1000 kilometres above the surface of the Earth. Examples of Earth-observation satellites based on SAR accordingly can have orbits with an altitude of between 450 kilometres and 650 kilometres above the Earth. In an example of satellites that would be suitable for implementing the methods described herein, a SAR satellite may have an orbit that is approximately 550 kilometres above the Earth's surface. At an orbit of 550 kilometres above the Earth, for example, the satellite may be effectively traversing the ground at approximately 7.5 kilometres per second, or 27,000 kilometres per hour. Most satellites in such an orbit will traverse the Earth at a speed that is in the range of 7-8 kilometres per second.

Whereas some traditional applications of SAR imagery may include developing digital elevation maps of terrain on a larger scale (for example, of mountains), detecting and monitoring dry-bulk stockpiles, especially smaller ones, requires higher resolution. In an example, the SAR Earth-monitoring satellite 100 may be able to image with a resolution of 15 metres or less, 10 metres or less, or 3 metres or less. Even high resolutions (e.g., 50 centimetre resolution) can serve to enhance the accuracy of the monitoring. Using the methods described herein, changes in volume of the monitored dry-bulk stockpiles much smaller than the resolution of SAR imaging techniques may also be detectable and quantifiable.

The methods described here use, where possible, first and second image data collected by one or more satellites orbiting around the Earth along different orbits that provide two different angles of viewing of the dry-bulk stockpile. In the context of the present application, ‘different orbits’ should be understood to mean that the one or more satellites are travelling along different orbital paths, or tracks, above the surface of the Earth. In other words, for a common imaging point, the one or more satellites will collect an image of said imaging point from respectively different look angles. The image data may be used to create images for display, either on board the satellite but more usually on Earth. Radargrammetric analysis is applied to the first and second image data to determine one or more properties of the dry-bulk stockpile. The one or more properties may comprise any of height, relative height, volume, area and any other dimension of the stockpile. Additionally or alternatively the radargrammetric analysis may be used to form an elevation model of the stockpile.

Radargrammetric analysis requires data collected from different angles to create a stereo image and is traditionally used for satellite imagery to estimate terrain height, for example to construct a digital elevation model showing mountains, oceans, and other large-scale geographical features. Examples are described here of methods of applying radargrammetric and interferometric analysis to satellite data for the monitoring of dry-bulk stockpiles, which tend to be smaller and change more quickly than terrain features such as mountains and hills that were traditionally mapped using radargrammetry.

An advantage of using satellite data, and particularly SAR data, for radargrammetric analysis is that there are satellites already in orbit above Earth that can be used to collect data. This is attractive compared to the required logistics and cost of some other alternatives for monitoring the dry-bulk stockpiles, e.g. aerial surveillance flight by aeroplane, to obtain the necessary data. However, some satellites may not have the capability to collect the data from the required different angles in a short enough period of time and with sufficient frequency for meaningful monitoring of the dry-bulk stockpiles. This problem is resolved in some of the methods described here by using and analyzing multiple images of a particular dry-bulk stockpile data collected by one or more satellites orbiting around the Earth.

The use of satellite data has additional advantages over conventional terrestrial-based imaging approaches. For example, monitoring dry-bulk stockpiles from space has significant advantages in terms of being able to obtain images of the dry-bulk stockpile. In some contexts and scenarios, the dry-bulk stockpile may be in a remote and/or restricted area such that it is not feasible to obtain images of the dry-bulk stockpile from a terrestrial imaging device. The use of satellite data also facilitates global coverage of the methods disclosed herein and may improve the frequency with which images of the dry-bulk stockpile can be collected.

Further, the use of satellite synthetic aperture radar data has advantages over approaches that use aerial photography. In particular, monitoring using aerial photography requires the use of dedicated aircraft and may be severely impacted by adverse weather conditions, particularly cloud cover. In contrast, satellite radar imaging can pierce cloud cover to obtain images of the dry-bulk stockpile.

The fact that the orbital paths, or tracks (such that a dry-bulk stockpile is imaged from different angles), are different may not be sufficient alone and in some methods it may additionally be necessary to verify that first and second image data meets additional requirements. For example it may be necessary to verify that the difference in look angle between the two images, i.e., the parallax angle as explained further below, is within a predetermined range. Where the additional requirements are not met, in some of the methods described here a different technique can potentially be used to determine one or more properties of the stockpile, such as SAR interferometric analysis, “InSAR”, thereby allowing for more frequent collection of data than previously possible, making the monitoring of the dry-bulk stockpiles more accurate.

As InSAR uses phase data, it is possible to detect very small changes between images. In some examples, InSAR analysis may be used to resolve differences corresponding to changes on the order of centimetres or millimetres. InSAR could also be used to quantify or to help quantify the height of a dry-bulk stockpile or the change in height of a dry-bulk stockpile.

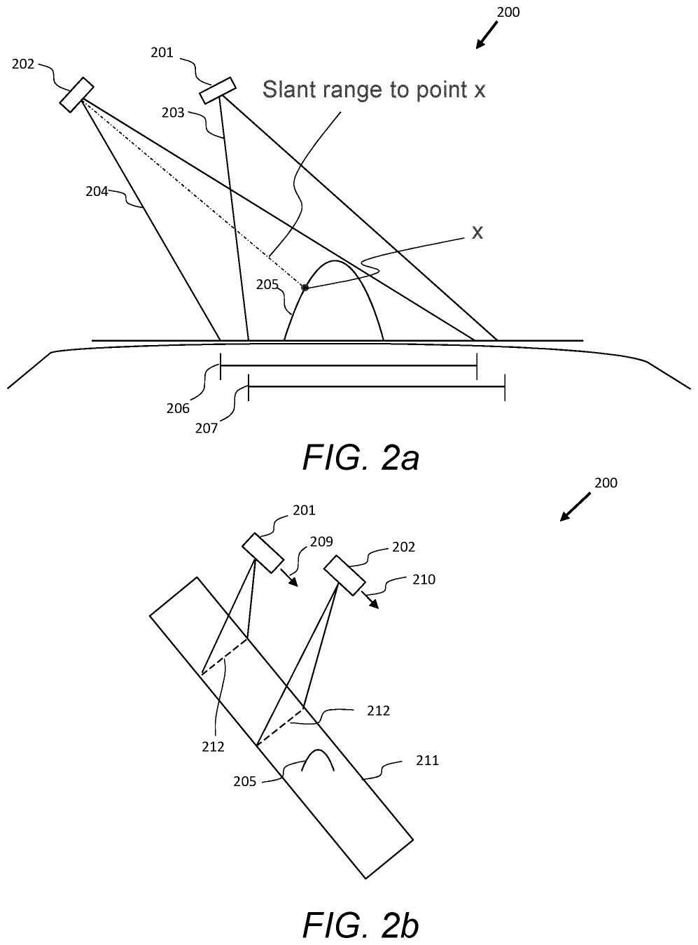

SAR satellites typically operate in a side-looking configuration. For the purpose of radargrammetric analysis, the satellites in different orbits may be same-side looking, or opposite-side looking, or any variation between these extremes. This is explained further with reference to FIGS. 2 to 5.

FIG. 2a is a schematic side elevation showing two satellites 201, 202 in low-Earth orbit having respective fields of view 203, 204 collecting an image of a dry-bulk stockpile 205 within the respective imaging areas 206, 207 of the two satellites 201, 202 on the surface of the Earth. Both of the satellites are side-looking. In the configuration of FIG. 2a, the fields of vision 203, 204 and imaging areas 206, 207 of the two satellites 201, 202 are intersecting in a same-side imaging configuration.

FIG. 2a shows two satellites 201, 202 in low-Earth orbit on different orbital paths around the Earth. Some of the methods described here may be performed using two satellites 201, 202 following the same orbital path around the Earth. Alternatively, some of the methods described here may be performed using the same satellite but collecting the two images of the dry-bulk stockpile 205 at different times, either at different times in the same pass or during different passes of the areas.

FIG. 2b is a perspective view of the satellites shown in FIG. 2a. The two satellites 201, 202 are orbiting along respective orbital paths 209, 210. In the example shown in FIG. 2b, the orbital paths 209, 210 of each of the satellites 201, 202 are shown as being substantially parallel. The skilled person will however appreciate that the orbital paths 209, 210 of the two satellites need not be parallel and may indeed be oriented at any angle relative to one another. The orbital paths 209, 210 define respective along-track, or azimuthal, axes for the respective image data collected by each of the satellites 201, 202. In the case of parallel, or substantially parallel, orbital paths 209, 210, the two satellites 201, 202 may obtain image data from a common ground track 211 and the direction of the orbital paths 209, 210 may define the azimuthal axis for images collected along the common ground track 211. The direction orthogonal to the azimuthal direction along the common ground track 211 is generally referred to as the range direction, being a direction crossing the ground track 211 transverse to the azimuthal direction.

The extent of the imaging areas 206, 207 of each of the satellites 201, 202 in the range direction may be referred to as respective swaths of each of the satellites 201, 202. The overlap of the two imaging areas 206, 207 in the range direction may define a common, overlapping swath 212. The common swath 212 defines an area in which the dry-bulk stockpile imaged by both satellites 201, 202 can be found.

FIG. 2b shows both satellites 201 and 202 in a side-looking configuration imaging the ground track looking orthogonal to their directions of travel 209 and 210 respectively. The position of the two satellites is different, so they are imaging the common swath 212 from different angles. Although the satellites in FIG. 2b are shown as purely side-looking, they could also be forward looking or backwards looking along the ground swath.

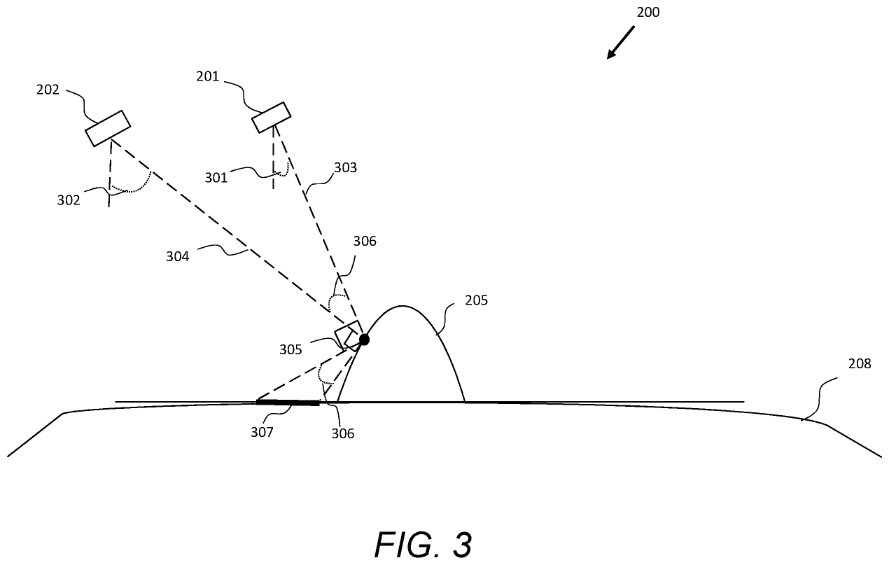

FIG. 3 is a schematic depicting the geometry of the imaging system of the two satellites in FIGS. 2a-b. As can be seen from FIG. 3, the first satellite 201 images the dry-bulk stockpile 205 from a first look angle 301 along a first line of sight 303 and the second satellite 202 images the dry-bulk stockpile 205 from a second look angle 302 along a second line of sight 304. In practice a radar beam is scanning the field of view or imaging area and therefore the line of sight may be defined as a straight line between the centre of an antenna of the satellite and the centre of and imaging area on the ground. The look angle of a satellite may be defined as the angle between the line of sight and an imaginary line connecting the satellite to its nadir on the ground—the nadir being the point on the surface of the Earth directly below the satellite. The lines of sight 303, 304 of each satellite 201, 202 intersect at an intersection point 305. The intersection point 305 is a point, in the images collected by the first and second satellites 210, 202, on the surface of the dry-bulk stockpile 205 being imaged by the first and second satellite 201, 202. Over the course of an imaging process, each of the first and second satellites may scan across the surface of the dry-bulk stockpile, for example in the range and/or azimuthal directions to generate a plurality of intersection points 305 that can be used in radragrammetry and/or interferometry analysis, as discussed below.

The angle 306 between the two lines of sight 303, 304 may be referred to as the parallax angle 306. The value of the parallax angle may be used, for example, to determine whether interferometry or radargrammetry analysis should be applied to analyse the dry-bulk stockpile 205—this is discussed in more detail below.

Note that when using radargrammetry, the location of point 305 on the ground will appear to be closer than it actually is if projected straight down to the surface of the Earth. This is because the distance to points on the ground are measured by the time of flight of the radar signal. When the object is higher, it is slightly closer to the satellite and as such its position on the ground will appear in the SAR image as being closer. In an example of radagrammetric analysis, a line 307 on the surface of the Earth, on which the dry-bulk stockpile sits, that is subtended by the parallax angle 306 may be referred to as the parallax arc 307. The parallax arc 307 represents the difference in offset on the ground from the true location of point 305 between the two different imaging locations. As such, this fact can be used to estimate the height of point 305 using trigonometry. The parallax arc 307 is directly proportional to the elevation—i.e., the relative height—of the intersection point 305 above the reference level of the ground. In other words, for a given parallax angle 306 between the lines of sight 303, 304 of two satellites 201, 202 in a same-side imaging configuration, the parallax arc 307 may be measured to determine the relative height above the ground of the intersection point 305 according to the Equation (1):

$$h = d / ( cot {θ}_{2} - cot {θ}_{1} ) \qquad ( 1 )$$

wherein d is the length of the parallax arc 307, h is the relative height of the intersection point 305, and θ₁ and θ₂ are the look angles 301, 302 of the first and second satellites 201, 202 respectively. In this example, an assumption is made that the height of the satellite is much greater than the relative height, h, of the point on the dry-bulk stockpile being measured. The elevation of the ground can be determined from a digital elevation model of the area, or from assumptions of the elevation at the base of the stockpile and added to the relative height to determine the absolute elevation of point 305. For example, many stockpiles are located at ports and the base of the stockpile could, for example, to be located at sea level. This process can then be repeated for multiple points on the surface of the dry-bulk stockpile and volume estimates can be made based on the typical geometry of the dry-bulk stockpile. However, this does not take into account stockpiles with irregular shapes. Taking multiple points can help improve the accuracy of the volume estimate, and the more points that are calculated the more accurate the estimation of the stockpile volume will be.

In another example, if the elevation of the base of the stockpile is unknown or greater accuracy is required than what making assumptions can provide, a radargrammetric analysis technique that is known in the art can be applied to determine the absolute heights of each of the points on top of the dry-bulk stockpile and at the base of the dry-bulk stockpile to determine the elevation at the bottom of the stockpile. This radargrammetric method involves forming a system of equations representing the intersection of the two SAR images range rings and their Doppler cones. This results in a system of four equations with three unknowns (X, Y and Z position of intersection point) that can be solved for, according to methods that will be known to one skilled in the art. Whereas the method in this example has the benefit of not requiring a DEM, it is also more complicated and hence more computationally intensive.

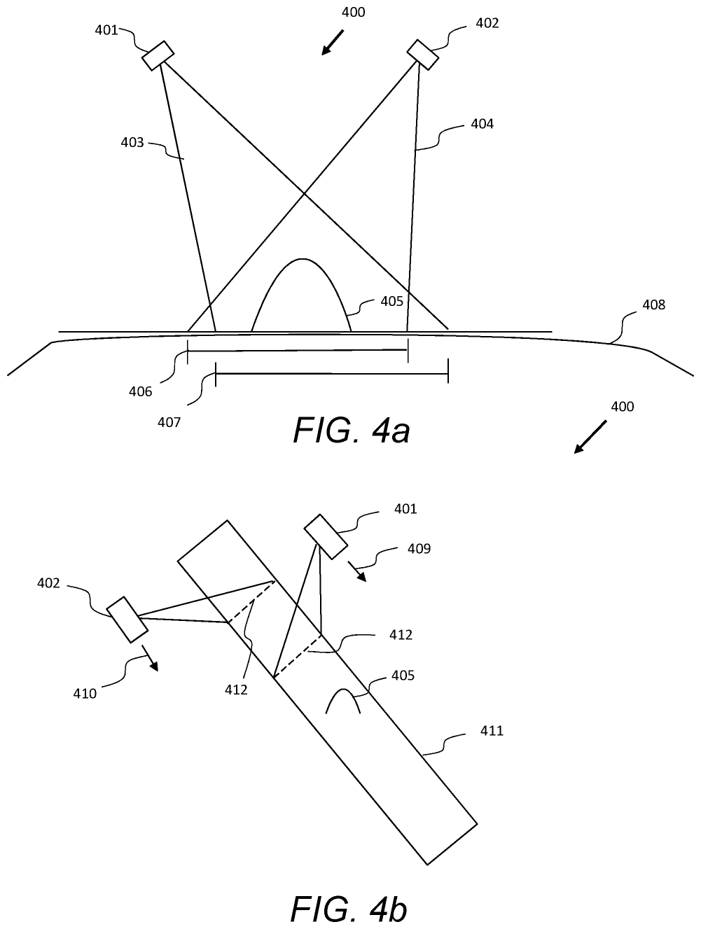

FIG. 4a is a schematic showing two satellites in orbit around the Earth, collecting an image of a dry-bulk stockpile with the imaging areas of the two satellites intersecting in an opposite-side imaging configuration.

Similar to the configuration shown in FIG. 2a, FIG. 4a shows side elevation views of two satellites 401, 402 having respective fields of visions 403, 404 collecting an image of a dry-bulk stockpile 405 within the respective imaging areas 406, 407 of the two satellites 401, 402 on the surface of the Earth. in the configuration of FIG. 4a, the fields of vision 403, 404 and imaging areas 406, 407 of the two satellites 401, 402 are intersecting in an opposite-side imaging configuration.

In SAR imaging, a satellite is typically not configured to pass directly overhead of the imaging target—in this case a dry-bulk stockpile 405. In an example, the two satellites 401, 402 may be two distinct satellites on different orbital paths around the Earth. The two satellites 401 and 402 could also be the same satellite imaging from position 401 on one orbital pass and from position 402 in a second orbital pass. The second orbital path is configured in this example to take an image of the dry-bulk stockpile 405 from the other side

FIG. 4b is a schematic showing a perspective view corresponding to FIG. 4a. The two satellites 401, 402 are orbiting along respective orbital paths 409, 410, for example in low-Earth orbit. In the example shown in FIG. 4b, the orbital paths 409, 410 of each of the satellites 401, 402 are shown as being substantially parallel. The skilled person will however appreciate that the orbital paths 409, 410 of the two satellites need not be parallel and may indeed be oriented at any angle relative to one another. As with FIG. 2b, the orbital paths 409, 410 depicted in FIG. 4b define respective azimuthal axes for the respective images collected by each of the satellites 401, 402. In the case of parallel, or substantially parallel orbital paths 409, 410, the two satellites 401, 402 may obtain image data from a common ground track 411. The direction orthogonal to the azimuthal direction along the common ground track 411 is the range direction, and the extent of the imaging areas 406, 407 of each of the satellites 401, 402 in the range direction may be referred to as the respective swaths of each of the satellites 401, 402. The overlap of the two imaging areas 406, 407 defines a common, overlapping swath 412. The common swath 412 defines an area in which the dry-bulk stockpile 405 imaged by both satellites can be found.

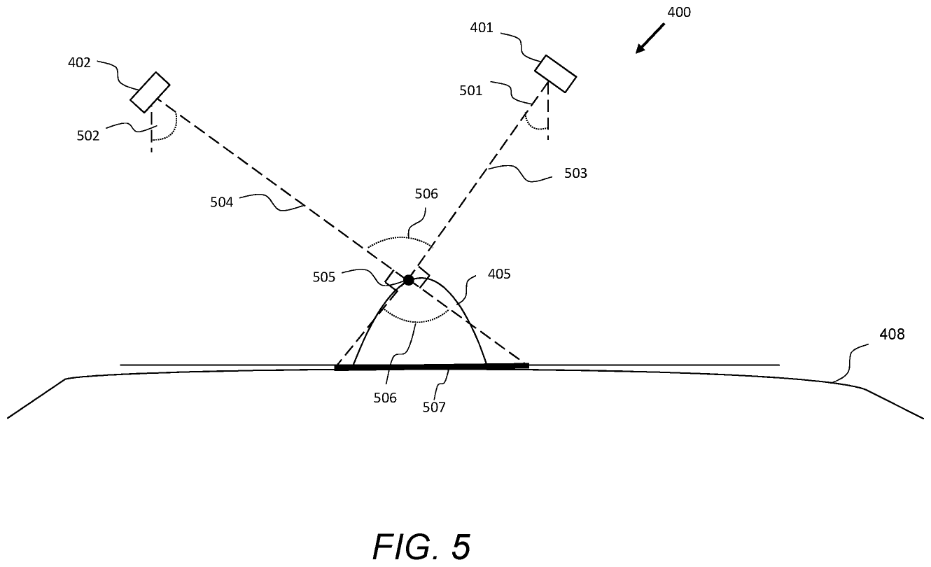

FIG. 5 is a schematic depicting the parallax (intersection) angle of the two satellites in FIGS. 4a-b. As can be seen from FIG. 4, the first satellite 401 images the dry-bulk stockpile 405 from a first look angle 501 and the second satellite 402 images the dry-bulk stockpile 405 from a second look angle 502 along first and second lines of sight 503, 504 respectively. The look angles may be defined as discussed above in relation to FIG. 3. The lines of sight 503, 504 of each satellite intersect at an intersection point 505. The intersection point 505 is a point on the surface of the dry-bulk stockpile 405 being imaged by the first and second satellite 401, 402. Over the course of an imaging process, each of the first and second satellites may scan across the surface of the dry-bulk stockpile, for example in the range and/or azimuthal directions to generate a plurality of intersection points 505 that can be used in radargrammetry analysis, as discussed below.

In an example, the angle 506 between the two lines of sight 503, 504 is the parallax angle, as defined above in relation to FIG. 3. The value of the parallax angle 506 may be used, for example, to determine whether radargrammetry analysis can be applied to analyse the dry-bulk stockpile 405—this is discussed in more detail below. The line 507 on the surface of the earth that is subtended by the parallax angle is the parallax arc, as introduced above in relation to FIG. 3. the parallax arc 507 is directly proportional to the relative height of the intersection point 505. For a given parallax angle 506 between the lines of sight 503, 504 of two satellites 401, 402 in an opposite-side imaging configuration, the parallax arc 507 may be measured to determine the elevation of the intersection point 505 according to the following Equation (2):

$$h = d / ( cot {θ}_{2} + cot {θ}_{1} ) \qquad ( 2 )$$

wherein d is the length of the parallax arc 507, h is the relative height of the intersection point 505 above the round, and θ₁ and θ₂ are the look angles 501, 502 of the first and second satellites 401, 402 respectively.

It will be noted from a comparison of Equations (1) and (2) that the calculation of d depends on whether the two satellites are same-side looking or opposite-side looking. The opposite-side imaging configuration has the advantage of a stronger stereo geometry than looking from the same side. It also is better able to image the other side of the dry-bulk stockpile. While this can work with the radargrammetry examples and methods described above, in practice looking from opposite sides can make it more difficult to match the two images because the area being imaged can look quite different when viewed from the opposite side, leading potentially to increased void areas in the image.

In an example, the practical issues with the opposite side imaging configuration can be solved by acquiring two images from each side, and then merging them separately. This can provide strong stereo geometry over the entire scene while still allowing for good image matching due to similar geometry, thereby leading to more accurate results for the stockpile monitoring.

In accordance with the methods described herein, the imaging configurations of the satellites shown in FIGS. 2 to 5 may be used by satellites orbiting around the Earth to determine properties of dry-bulk stockpiles that are imaged through synthetic aperture radar (SAR) imaging.

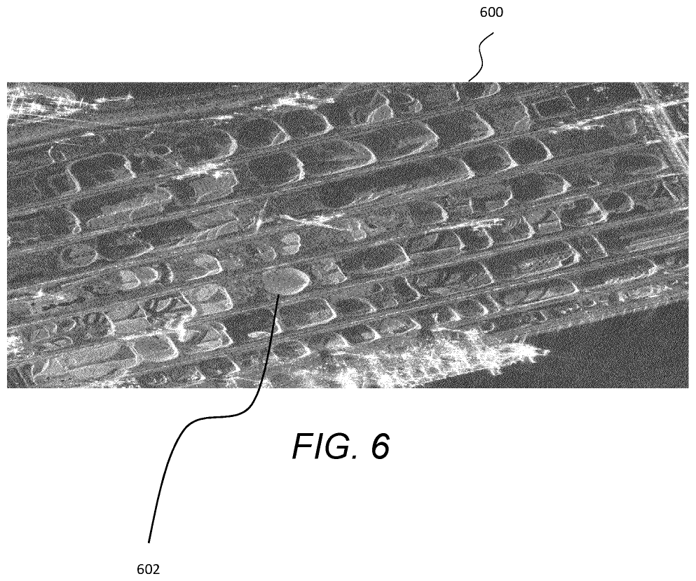

FIG. 6 shows an example SAR image 600 collected by a satellite in orbit around the Earth for the Port of Rotterdam in the Netherlands. Dry-bulk stockpiles 602 can be clearly seen arranged in rows in the SAR image. By applying radargrammetric and/or interferometric analysis to SAR images of dry-bulk stockpiles, such as the SAR image 600 shown in FIG. 6, it is possible to determine the properties of the dry-bulk stockpiles without requiring access either to the stockpile site, or the airspace in the vicinity of the stockpile site.

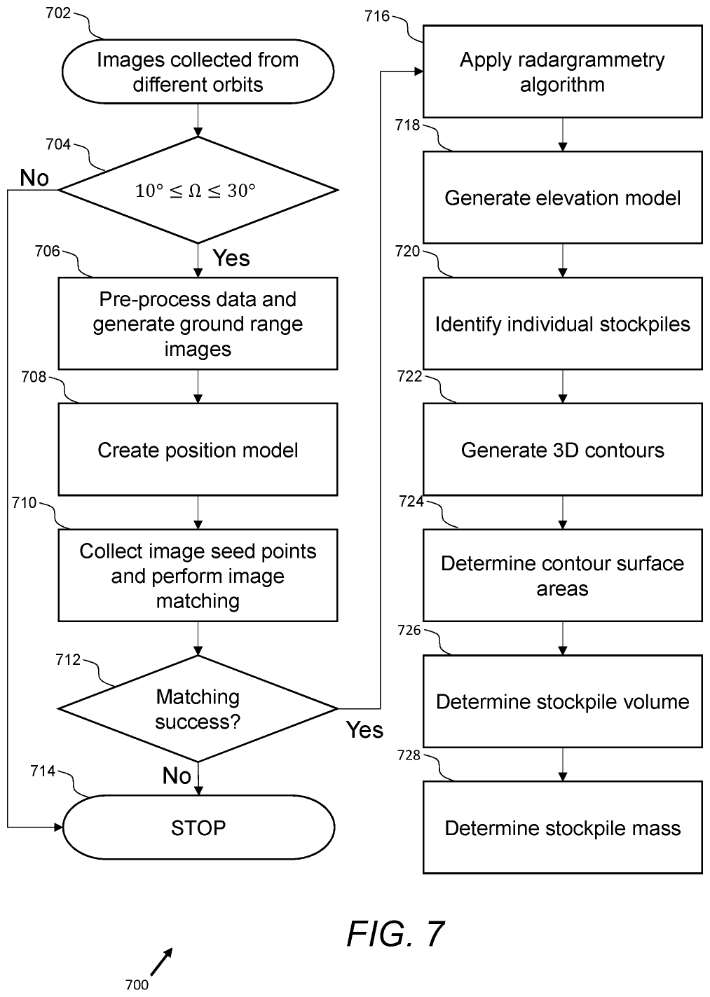

FIG. 7 is a flowchart of a method 700 of monitoring and estimating the volume of a dry-bulk stockpile based on radargrammetry analysis. As is discussed in more detail below, radargrammetry can be used as part of the method 700 to determine relative heights and/or to generate an elevation model of the dry-bulk stockpile 205, 405. As a starting condition 702, the SAR images collected respectively by the first and second satellite 201, 202, 401, 402 are collected by either one satellite that has moved from one orbital path 209, 409 to another orbital path 210, 410; or two different satellites travelling along separate orbital paths 209, 210, 409, 410. The image data related to each of the two SAR images that is processed according to the methods described herein may be referred to as first and second image data respectively. The first image data may correspond to an SAR image of a first area that includes at least one dry-bulk stockpile and the second image data may correspond to an SAR image of a second area that includes the same at least one dry-bulk stockpile.

An operation 704 of the method may comprise verifying that the parallax angle 305, 505 is within a predetermined range. The predetermined range may define a range of parallax angles within which applying radargrammetric analysis may practically yield the most meaningful and/or accurate information about one or more properties of the dry-bulk stockpile 205, 405.

The predetermined range may be defined by a lower bound. The lower bound defining the predetermined range may be 2.5 degree or less, 5 degrees or less, 7.5 degrees or lees, 10 degrees or less, 15 degrees or less, or 20 degrees or less.

Additionally or alternatively, the predetermined range may be defined by an upper bound. The upper bound defining the predetermined range may be 20 degrees or more, 25 degrees or more, 30 degrees or more, 35 degrees or more, or 40 degrees or more.

Additionally or alternatively, the predetermined range may be a range of 2.5 degrees to 20 degrees, 2.5 degrees to 25 degrees, 2.5 degrees to 30 degrees, 2.5 degrees to 35 degrees, 2.5 degrees to 40 degrees; 5 degrees to 20 degrees, 5 degrees to 25 degrees, 5 degrees to 30 degrees, 5 degrees to 35 degrees, 5 degrees to 40 degrees; 7.5 degrees to 20 degrees, 7.5 degrees to 25 degrees, 7.5 degrees to 30 degrees, 7.5 degrees to 35 degrees, 7.5 degrees to 40 degrees; 10 degrees to 20 degrees, 10 degrees to 25 degrees, 10 degrees to 30 degrees, 10 degrees to 35 degrees, 10 degrees to 40 degrees; 15 degrees to 20 degrees, 15 degrees to 25 degrees, 15 degrees to 30 degrees, 15 degrees to 35 degrees, 15 degrees to 40 degrees; 20 degrees—or substantially 20 degrees, 20 degrees to 25 degrees, 20 degrees to 30 degrees, 20 degrees to 35 degrees, or 20 degrees to 40 degrees.

In one particular example, such as that shown in FIG. 7, the predetermined range is 10 degrees to 30 degrees.

If the verification in operation 704 that the parallax angle 305, 505 does lie within the predetermined range is successful, then method 700 proceeds to a subsequent operation.

Raw SAR image data is generated in the reference frame of the satellite that collected the SAR data, i.e., the axes of any generated SAR image correspond to axes that are stationary in the rest frame of the satellite. In this reference frame, the frame direction is parallel to the line of sight of the satellite. The distance between each satellite 201, 202, 401, 402 and a respective imaging subject (in these examples, the dry-bulk stockpile 205, 405) in the frame direction is referred to as the slant range. Meanwhile, the distance between the nadir of the satellite 201, 202, 401, 402 (i.e. the point on the satellite's ground-track 211, 411 directly underneath the satellite 201, 202, 401, 402) and the imaging subject is referred to as the ground range. Due to the existence of the parallax angle 305, 505 between the two satellites 201, 202, 401, 402 that collect the images, the slant range, and the frame direction, for each of the first and second SAR image data will be different. This may make combining the two images via radargrammetric analysis more difficult and impact the accuracy of the determination of the one or more properties of the dry-bulk stockpile 205, 405.

Therefore, the first and second image data corresponding to respective slant ranges may optionally be transformed to correspond to synthetic aperture radar images in respective ground ranges.

To this effect, operation 706 comprises pre-processing the first and second image data and converting the raw image data from data corresponding to SAR images in the slant range to data corresponding to SAR images in the ground range.

In a further operation 708, to enable a more accurate application of a radargrammetry algorithm, it may be beneficial to generate a position model. The position model may detail the relative positions of each of the two satellites 201, 202, 401, 402 relative to each other and to the dry-bulk stockpile 205, 405 at the time at which the first and second image data were respectively collected. The determination of the one or more properties of the dry-bulk stockpile may be based on the position model.

In some embodiments, the application of radargrammetric analysis may comprise identifying one or more matching points in the first and second image data, and extrapolating an elevation model of the dry-bulk stockpile based on the one or more matching points, as discussed below in relation to operations 710 to 718.

In a specific example shown in FIG. 7, a further operation 710 comprises collecting one or more image seed points from each of the first and second image data. The image seed points may correspond to pixels of the two SAR images collected respectively by the first and second satellite 202, 203, 402, 403. In some examples, the image seed points may correspond to a feature in the SAR images that is readily recognizable across different images. Such a feature may, for example, include: a corner, a land feature, a building, etc. Operation 710 may further comprise performing image matching for the first and second image data to identify the image seed points in the first and second image data that correspond to intersection points 306, 506 of the lines of sight 303, 304, 503, 504 from the first and second satellites 202, 203, 402, 403 to the dry-bulk stockpile 205, 405. Identifying these matching points may enable the radargrammetry algorithm to generate an elevation model of the dry-bulk stockpile 205, 405 at operation 718 described further below. This may involve, for example, determining an elevation or relative height of each of the matching points. This may additionally or alternatively involve, determining a latitude and/or longitude for each matching point based on the position model generated in operation 708 above.

The position model can be generated and the matching points identified for a wide range of satellite orbital configurations and imaging acquisition geometries. As discussed above, radargrammetry is possible both in same-side (see FIGS. 2 and 3) and opposite-side (see FIGS. 4 and 5) imaging geometries, each of which has its own advantages. Same-side radargrammetry enjoys a benefit that there typically may be a larger number of intersection points 306, 506 than can be found in opposite-side radargrammetry, for the same parallax angle 305, 505.

Radargrammetry, as described herein, may find particular use when the SAR images upon which the first and second image data may be collected by satellites within a satellite constellation, each satellite in the constellation having a different (and possibly varying) orbit. A constellation of satellites may be understood as being a group of satellites that are centrally controlled. In other words each of the satellites within a constellation may be controlled by a single controller. In some examples, each of the satellites within the constellation may be orbiting the earth with the same, or substantially similar, altitude. Image data collected by different satellites within the constellation may nonetheless be recorded in the same, or similar, format to facilitate the easy combination and processing of data collected by different satellites in the constellation. In such constellations, there is the possibility for the opportunistic acquisition of an area including the dry-bulk stockpile 205, 405 with varying acquisition geometries. This advantage is particularly prevalent if the constellation of satellites comprises a plurality of agile lightweight satellites, sometimes referred to as micro-satellites, because of the high degree of manoeuvrability. Moreover, in large agile constellations there are very few, or sometimes zero, orbital or geometric constraints meaning that the area including the dry-bulk stockpile can be covered more frequently. In such situations, opposite-side radargrammetry may be particularly advantageous, despite the lower number of intersection points 306, 506 when compared with same-side radargrammetry. Nonetheless, opposite-side radargrammetry may still be feasible and yield meaningful determinations of one or more properties of the dry-bulk stockpile 205, 405, especially if the parallax angle 305, 505 does not exceed a predetermined threshold. The predetermined threshold may, for example, be 20 degrees or more, 25 degrees or more, 30 degrees or more, 35 degrees or more, or 40 degrees or more. In one particular example, the predetermined threshold may be 30 degrees. In some examples, the predetermined threshold may be the same as the upper bound of the predetermined range discussed above in relation to operation 704.

A further operation 712 may comprise verifying that the image matching of operation 710 was successful. Successful image matching may be recognised as identifying a number of intersection points 305, 505, wherein the number of identifying intersection points exceeds a predetermined threshold. The predetermined threshold may, for example, be any number between two and fifty intersection points on the dry-bulk stockpile.

If operation 712 determines that the image matching was unsuccessful then the method aborts and stops at operation 714. Similarly, if it is determined at operation 704 that the parallax angle is outside the predetermined range, the method aborts and stops at operation 714.

However, if operation 712 determines that the image matching was successful then the method proceeds to operation 716. Operation 716 comprises applying a radargrammetry algorithm, i.e., applying radargrammetric analysis, to the first and second image data. The radargrammetry analysis takes as input intensity values in the first and second image data, the intensity values being indicative of the intensity of an SAR signal received at each pixel of the SAR images respectively collected by the first and second satellites 201, 202, 401, 402.

Each of operations 718 to 728 may be considered to be part of the application of the radargrammetric analysis that is commenced in operation 716. For example, in a further operation 718, applying the radargrammetric analysis may comprise generating an elevation model of the dry-bulk stockpile.

It will be clear from the foregoing that applying radargrammetric analysis may comprise determining relative heights or an elevation model of a radargrammetry area based on: a comparison between the first image data and the second image data; and a parallax angle between a first line of sight from the satellite that collected the first image data to the dry-bulk stockpile, and a second line of sight from the satellite that collected the second image data to the dry-bulk stockpile. The radargrametry area may include the dry-bulk stockpile and may be defined by an overlap between the first and second areas.

In a further operation, 720, applying the radargrammetric analysis may comprise: identifying each of the plurality of dry-bulk stockpiles in each of the first and second image data; and applying the methods disclosed herein to each of the identified dry-bulk stockpiles.

A further operation 722 comprises determining a plurality of contours of the dry-bulk stockpile, wherein each of the plurality of contours corresponds to a different elevation of the dry-bulk stockpile. In some examples, the contours may be generated across the digital elevation model and used to identify the one or more individual dry-bulk stockpiles in the imaging area of the first and second satellites. In other examples, the contours may be generated after the identification of the one or more individual dry-bulk stockpiles and may be generated only for the dry-bulk stockpiles—this may reduce the computational cost of implementing the methods described herein.

The determined contours may be equally spaced across the elevation of the dry-bulk stockpile.

A further operation 724 comprises determining the surface area of at least some of the generated contours. In some examples, the surface area of the uppermost and lowermost contour is determined. In some examples, the surface area of each of the generated contours is determined. In some examples, the surface area of a given contours is determined based on a numerical integration process based on the determined perimeter of the contour.

In some embodiments, the one or more properties of the dry-bulk stockpile may be determined based on the plurality of contours. For example a further operation 726 comprises determining the volume of each of the one or more dry-bulk stockpiles being analysed according to the methods described herein.

A further operation 728 comprises determining the mass of each of the one or more dry-bulk stockpiles being analysed according to the methods described herein.

In some examples, additional or alternative properties of each of the dry-bulk stockpiles may be determined.

In some embodiments, the one or more properties of the dry-bulk stockpile may include a volume of the dry-bulk stockpile. Determining the volume of the dry-bulk stockpile may comprise: determining a respective surface area of an uppermost contour and a lowermost contour; interpolating a model outline of the dry-bulk stockpile between the uppermost contour and the lowermost contour; determining a height for the base of the dry-bulk stockpile; and determining the volume based on the model outline of the dry-bulk stockpile.

In some embodiments, the method may further comprise: determining a respective surface area of each of the contours between the uppermost and lower most contour. Interpolating the model outline may comprise interpolating the model outline of the dry-bulk stockpile between each pair of neighbouring contours.

In other words, the volume of the dry-bulk stockpile may be determined by equating the contour surface areas determined in operation 724 to a cross-sectional area of a corresponding dry-bulk stockpile and integrating the variations in the dry-bulk stockpile's cross-sectional area over its determined height (the height being the change in elevation between the uppermost and lowermost contour) to determine the volume of the dry-bulk stockpile.

The mass of the dry-bulk stockpile may be determined if it is known (or if it is possible to know) which material the dry-bulk stockpile is formed from. In such an example, the mass of the dry-bulk stockpile is obtained by multiplying the density of the material by the determined volume. The density may be obtainable by reference to a look-up table or similar.

In some embodiments, the one or more properties may include one or more of: a volume of the dry-bulk stockpile; a surface area of the dry-bulk stockpile; a height of the dry-bulk stockpile; and a mass of the dry-bulk stockpile.

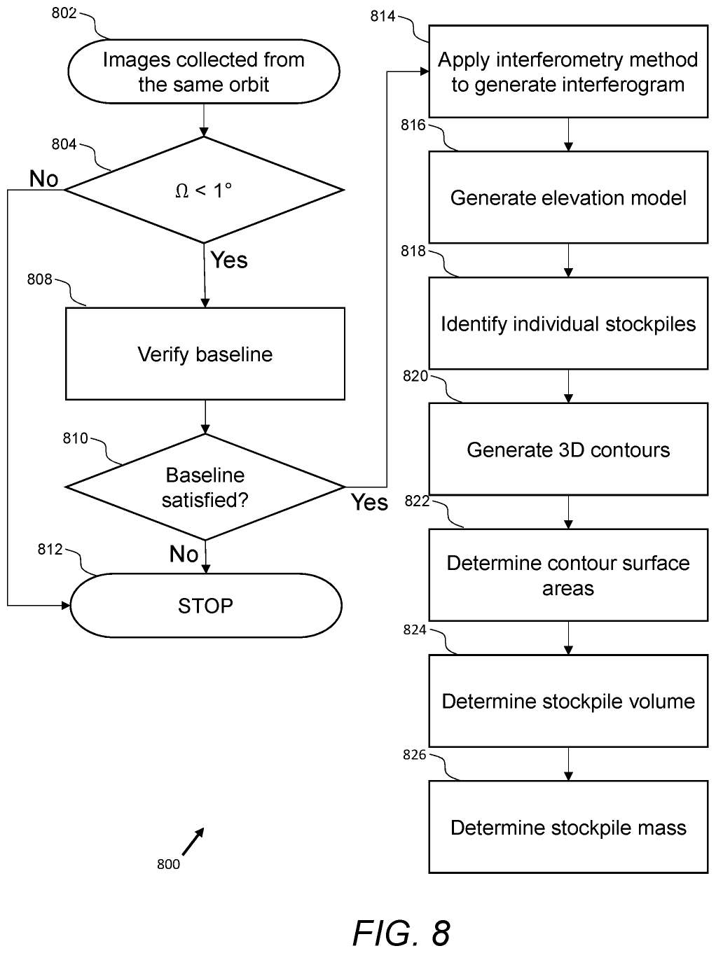

FIG. 8 is a flowchart of a method 800 of monitoring and estimating the volume of a dry-bulk stockpile based on interferometric analysis. As is discussed in more detail below, interferometry can be used as part of the method 800 to generate an interferogram and elevation model of the dry-bulk stockpile 205. As a starting condition 802, the two collected SAR images are collected by either a single satellite at two different time points along its orbit or by two satellites travelling along the same orbital path around the Earth such that the two images are taken from roughly the same imaging geometry, as characterised by a low difference in the imaging angle between the two images. The image data related to each of the two SAR images that is processed according to the methods described herein may be referred to as first and second image data respectively. The first image data may correspond to an SAR image of a first area that includes at least one dry-bulk stockpile, and the second image data may correspond to an SAR image of a second area that includes the same at least one dry-bulk stockpile.

An operation 804 of the method comprises verifying that the parallax angle 305 is less than a predetermined threshold. The predetermined threshold may define an upper limit below which applying interferometric analysis may yield meaningful and/or accurate information about one or more properties of the dry-bulk stockpile 205. If the parallax angle is too large, this may reduce the coherence of the first and second image data to the extent that interferometry between the images corresponding to the first and second image data is rendered impossible.

The predetermined threshold may, for example be 0.1 degrees or less, 0.5 degrees or less, 1 degree or less, 1.5 degrees or less, 2 degrees or less, or 5 degrees or less. In one particular example, such as that shown in FIG. 8, the predetermined threshold is 1 degree.

If the verification in operation 804 that the parallax angle 305 is below the predetermined threshold is successful, then method 800 proceeds to a subsequent operation.

As discussed above in relation to FIG. 7, raw SAR image data is generated in the reference frame of the satellite and is imaged in the slant range.

In some embodiments, the method may further comprise, before applying interferometric analysis: determining a degree of coherence between the first and second image data; and verifying that the degree of coherence exceeds a predetermined coherence threshold. The interferometric analysis may only be applied if the degree of coherence exceeds the coherence threshold. The degree of coherence threshold may, for example, be 0.5 or more, 0.6 or more, 0.7 or more, 0.8 or more, or 0.9 or more.

The coherence threshold may, for example, be a requirement that a baseline is shorter than a predetermined baseline threshold. The baseline threshold may in some examples, be 100 metres or more, 250 metres or more, 500 metres or more, 750 metres or more, or 1000 metres or more. In other examples the baseline threshold may in some examples 1000 metres or less, 750 metres or less, 500 metres or less, 250 metres or less, or 100 metres or less. Alternatively, in some examples, the requirement may be that the baseline is within a predetermined baseline range. For example the baseline range may be 100 metres to 250 metres, or 100 metres to 500 metres, or 100 metres to 750 metres, or 100 metres to 1000 metres; or 250 metres to 500 metres, or 250 metres or 750 metres, or 250 metres to 1000 metres; or 500 metres to 750 metres, or 500 metres to 1000 metres; or 750 metres to 1000 metres.

An example of the coherence determination is shown in FIG. 8 where further operation 810 may comprise verifying that a baseline condition of the imaging system is satisfied. In the context of satellite-based InSAR, the baseline for interferometric analysis is the distance between the location of the satellite that collected the first image data at the time when the first image data was collected and the location of the satellite that collected the second image data at the time when the second image data was collected. The shorter the baseline, the higher the degree of coherence between the first and second image data. Coherence between the first and second image data is vitally important because if the images lack coherence then interferometric analysis will not be possible. Critically, the perpendicular component of the baseline, i.e., the component of the baseline perpendicular to the line of sight of the first satellite, must satisfy the baseline threshold in most implementations.

If operation 810 determines that the baseline criterion is not satisfied then the method 800 aborts and stops at operation 812. Similarly, if it is determined at operation 804 that the parallax angle 305 is greater than the predetermined threshold, the method 800 aborts and stops at operation 812.

However, if operation 812 determines that the baseline criterion is satisfied then the method proceeds to operation 814. Operation 814 may comprise combining the first and second image data to generate an interferogram of an interferometry area. The interferometry area may include the dry-bulk stockpile and may be defined by an overlap between the first and second area. In a particular example this operation comprises applying an interferometry algorithm, i.e., applying interferometric analysis, to the first and second image data. The interferometry analysis takes as input both the real and complex values associated with the first and second image data. In other words, the interferometric analysis is based on both the amplitude/intensity and phase information in the first and second image data.

Applying the interferometric analysis comprises generating an interferogram of an interferometry area that is defined by an overlap in the first and second areas and that includes one or more dry-bulk stockpiles.

Each of operations 816 to 826 may be considered to be part of the application of the interferometric analysis that is commenced in operation 814. For example, in a further operation 816, applying the interferometric analysis may comprises generating an elevation model of the dry-bulk stockpile. Generating the elevation model may involve ‘unwrapping’ the phase in the interferogram to obtain absolute phase values for each pixel in the first and second SAR images that is mapped to the interferogram. These absolute phase values may then be used to determine an elevation corresponding to the particular absolute phase value.

In a further operation, 818, the method may further comprise: identifying each of the plurality of dry-bulk stockpiles 205 in each of the first and second image data; and applying the methods disclosed herein to each of the identified dry-bulk stockpiles.

A further operation 820 comprises generating a plurality of three-dimensional contours. The generated contours may be indicative of a particular elevation of the digital elevation model. In some examples, the contours may be generated across the digital elevation model and used to identify the one or more individual dry-bulk stockpiles in the imaging areas corresponding to the first and second image data. In other examples, the contours may be generated after the identification of the one or more individual dry-bulk stockpiles and may be generated only for the dry-bulk stockpiles—this may reduce the computational cost of implementing the methods described herein.

A further operation 822 comprises determining the surface area of at least some of the generated contours. In some examples, the surface area of the uppermost and lowermost contour is determined. In some examples, the surface area of each of the generated contours is determined. In some examples, the surface area of a given contours is determined based on a numerical integration process based on the determined perimeter of the contour.

A further operation 824 comprises determining the volume of each of the one or more dry-bulk stockpiles being analysed according to the methods described herein.

A further operation 826 comprises determining the mass of each of the one or more dry-bulk stockpiles being analysed according to the methods described herein.

In some examples, additional or alternative properties of each of the dry-bulk stockpiles may be determined.

In some embodiments, the one or more properties of the dry-bulk stockpile may include a volume of the dry-bulk stockpile. Determining the volume of the dry-bulk stockpile may comprise: determining a respective surface area of an uppermost contour and a lowermost contour; interpolating a model outline of the dry-bulk stockpile between the uppermost contour and the lowermost contour; and determining the volume based on the model outline of the dry-bulk stockpile.

In some embodiments, the method may further comprise: determining a respective surface area of each of the contours between the uppermost and lower most contour. Interpolating the model outline may comprise interpolating the model outline of the dry-bulk stockpile between each pair of neighbouring contours.

In other words, the volume of the dry-bulk stockpile may be determined by equating the contour surface areas determined in operation 822 to a cross-sectional area of a corresponding dry-bulk stockpile and integrating the variations in the dry-bulk stockpile's cross-sectional area over its determined height (the height being the difference in elevation between the uppermost and lowermost contour) to determine the volume of the dry-bulk stockpile.

The mass of the dry-bulk stockpile may be determined if it is known (or if it is possible to know) which material the dry-bulk stockpile is formed from. In such an example, the mass of the dry-bulk stockpile is obtained by multiplying the density of the material by the determined volume. The density may be obtainable by reference to a look-up table or similar.

In some embodiments, the one or more properties may include one or more of: a volume of the dry-bulk stockpile; a surface area of the dry-bulk stockpile; a height of the dry-bulk stockpile; and a mass of the dry-bulk stockpile.

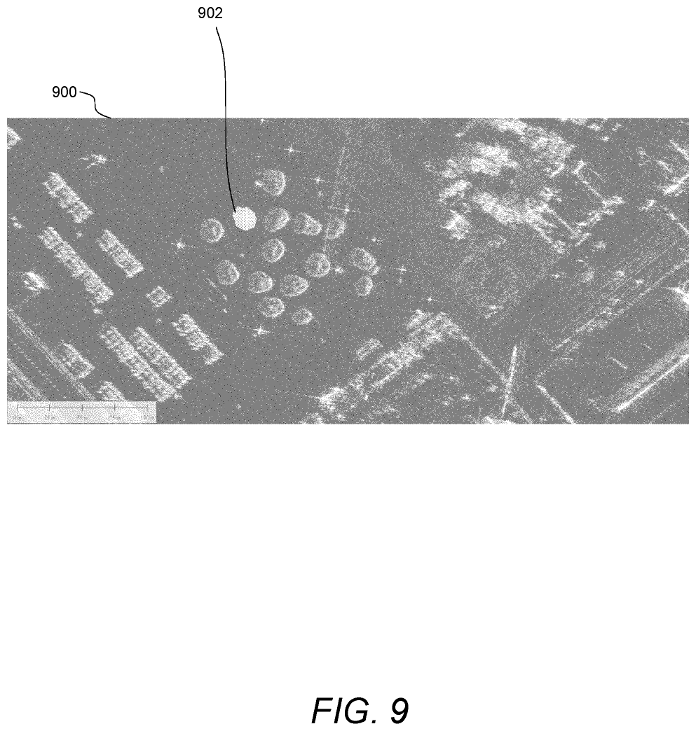

FIG. 9 shows an example of an SAR image 900 that can be used as input for the method of FIG. 8. A plurality of dry-bulk stockpiles can be seen in the SAR image 900 as a lattice of circular features in the centre of the image. For illustrative purposes, one of the dry-bulk stockpiles 902 has been highlighted as a solid-white feature in the SAR image 900. As future images are compared to this image using the method of FIG. 8, stockpiles with changes in them can easily be identified and highlighted.

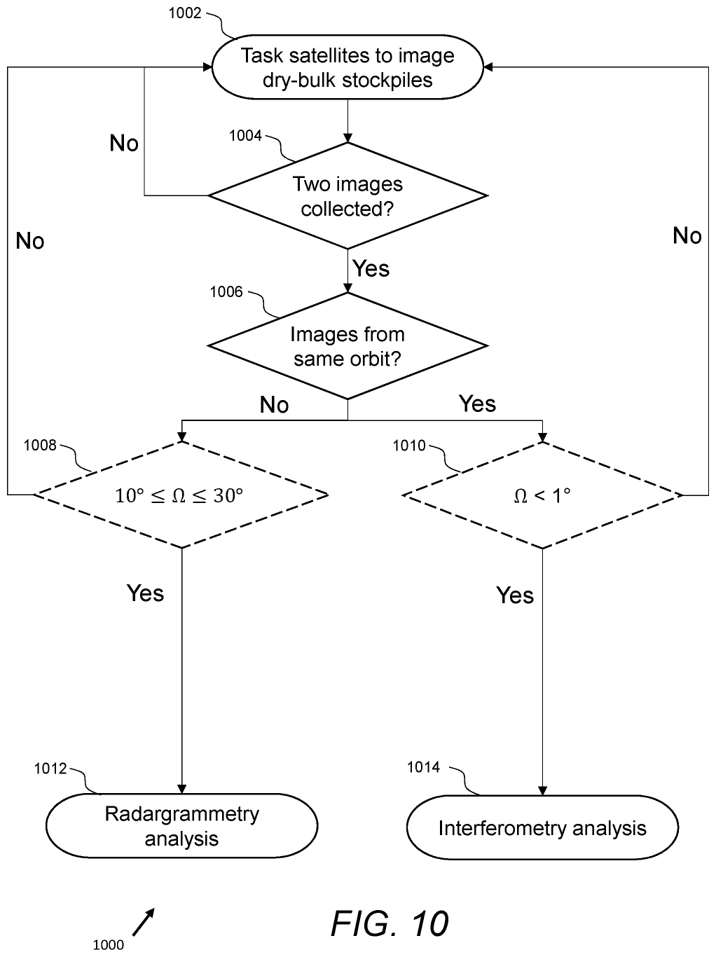

FIG. 10 is a flowchart of a method 1000 of monitoring and estimating the volume of a dry-bulk stockpile, wherein interferometric or radargrammetric analysis is selected based on the imaging conditions under which the dry-bulk stockpile is imaged.

A first operation 1002 comprises tasking a constellation of satellites to collet images of dry-bulk stockpiles. The constellation of satellites may comprise a plurality of satellites with some satellites on the same orbital path and other satellites on different orbits. Additionally, the satellites may be configured to collect SAR images of the surface of the Earth. In this way, the SAR images collected by the constellation of satellites may be suitable for either radargrammetric or interferometric analysis, depending on the conditions.

A further operation 1004 comprises verifying that at least two images of a same area including at least one dry-bulk stockpile 205, 405 have been collected. If no images of the area have been collected, or only one image of the area has been collected then further satellites are again tasked to image the area in a repeat of operation 1002.

If, however, two SAR images have been collected the method proceeds to operation 1006. Operation 1006 comprises verifying whether the two SAR images were collected by two satellites on different orbital paths around the Earth or by one or two satellites on the same orbit around the Earth. If the two images were collected by two satellites on different orbital paths around the Earth, method 1000 proceeds to apply radargrammetric analysis in operation 1012. Applying radargrammetric analysis in operation 1012 may involve applying the method 700 set out above in relation to FIG. 7. If, on the other hand, the two images were collected by one or more satellites on the same orbital path around the Earth, method 1000 proceeds to apply interferometric analysis in operation 1014. Applying interferometric analysis in operation 1012 may involve applying the method 800 set out above in relation to FIG. 8.

Additionally, prior to applying the radargrammetry and/or interferometry analysis, operations may be carried out to verify that the parallax angle lies either within a predetermined range (as discussed above in relation to operation 704 of FIG. 7) for radargrammetric analysis or below a predetermined threshold (as discussed above in relation to operation 804 of FIG. 8) for interferometric analysis in operations 1008 and 1010 respectively. If the parallax angle 305, 505 lies outside the predetermined range (for radargrammetry) or above the predetermined threshold (for interferometry), the method 1000 may return to operation 1002 and task the constellation of satellites to capture further SAR images of the dry-bulk stockpiles until the relevant criteria are satisfied in operations 1008 and 1010.

This method provides the operator of the satellite or constellation of satellites significantly more imaging opportunities, thereby allowing for more frequent repeats by satellites and hence more timely and accurate information for the customer.

In other words, in some embodiments, the method may further comprise: determining a parallax angle between a first line of sight from the satellite that collected the first image data to the dry-bulk stockpile and a second line of sight from the satellite that collected the second image data to the dry-bulk stockpile. If the first and second image data were collected by a satellite or multiple satellites on different orbits such that there is a difference in look angle between the first and second image, the method may further comprise verifying that the parallax angle is within a predetermined range. The radargrammetric analysis may only be applied if the parallax angle is within the predetermined range. Additionally or alternatively, if the first and second image data were collected by one or two satellites on the same orbit around the Earth such that the look angle (i.e., imaging geometry) or both images is sufficiently similar, the method may further comprise: verifying that the parallax angle is lower than a predetermined threshold. The interferometric analysis may only be applied if the parallax angle is lower than the predetermined threshold.

As the skilled person will appreciate, not only are the methods set out above suitable for determining one or more properties of the dry-bulk stockpile(s), they may also be used to compare the results of one application of the methods herein to the results of an earlier application of the methods herein to determine a change in the one or more properties.

In other words, in some embodiments, the determination of one or more properties of the dry-bulk stockpile may comprise comparing the results of the determination with previous results of a previous determination of the one or more properties of the dry-bulk stockpile to determine a change in the one or more properties.

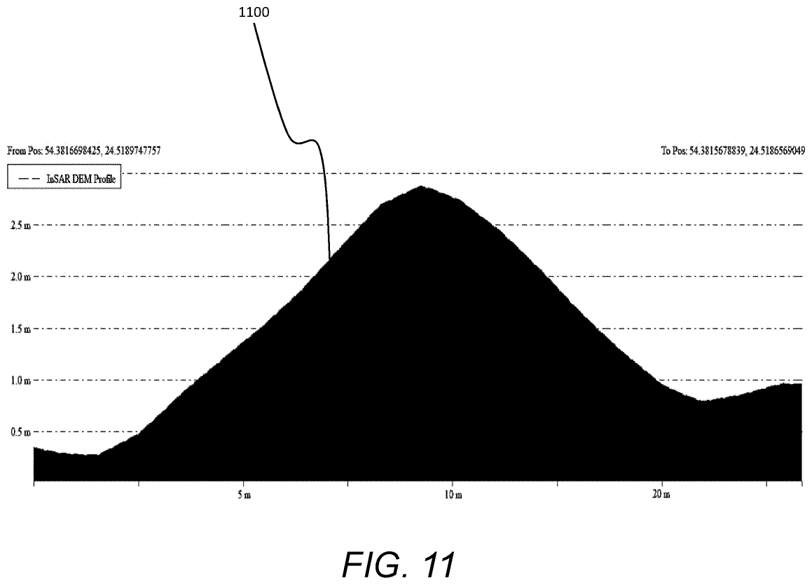

FIG. 11 shows an example of a profile line sampled from a digital elevation model showing a cross-section 1100 through a dry-bulk stockpile produced according to the methods descried herein. The digital elevation model 1100 may have been generated based on either radargrammetric or interferometric analysis as discussed above.

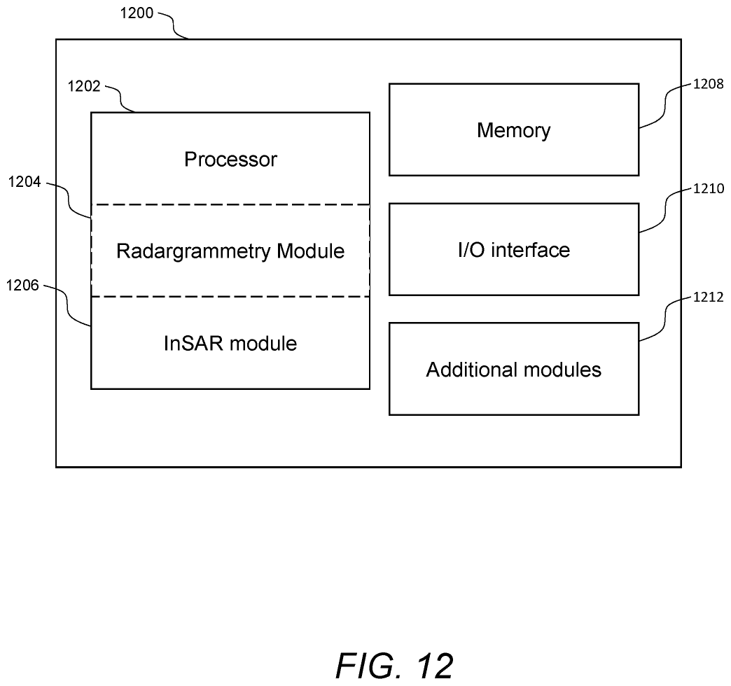

FIG. 12 shows a schematic of a computer 1200 comprising a processor 1202 configured to implement the methods described herein. To facilitate this the processor 1202 may comprise a dedicated radargrammetry module 1204 and/or a dedicated interferometry module 1206. The computer 1200 further comprises a memory 1208 configured to store, for example, the first and second image data and results of the radargrammetric and/or interferometric analysis. The computer further comprises one or more communications interfaces, for example an I/O interface 1210 for receiving and transmitting data. This may include receiving the first and second image data and/or transmitting the results of the radargrammetric and/or interferometric analysis. The computer 1200 may further comprise additional modules 1212 configure to carry out such operations as necessary for the functioning of the computer 1200 and the implementation of the methods described herein.

The embodiments described above are fully automatic. In some examples a user or operator of the system may manually instruct some steps of the method to be carried out.

In the described embodiments the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and Blu-ray® disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fibre optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A method of monitoring a dry-bulk stockpile, the method comprising:
receiving first image data collected by a satellite in orbit around Earth, wherein the first image data corresponds to a synthetic aperture radar image of a first area that includes the dry-bulk stockpile;
receiving second image data collected by a satellite in orbit around the Earth, wherein the second image data corresponds to a synthetic aperture radar image of a second area that includes the dry-bulk stockpile; and
applying radargrammetric analysis to the first and second image data to determine one or more properties of the dry-bulk stockpile.

2. The method according to claim 1, wherein the first image data is collected by a first satellite on a first orbit around the Earth and the second image data is collected by a second satellite on a second orbit around the Earth, wherein the first orbit is different from the second orbit.

3. The method of claim 1, the method further comprising:
determining whether the first and second image data were collected by one or two satellites on different orbits around the Earth with different look angles or by one or two satellites on a same orbit around the Earth with substantially similar look angles; and
if the first and second image data were collected by one or two satellites on different orbits with different look angles:
applying radargrammetric analysis to the first and second image data to determine one or more properties of the dry-bulk stockpile; or
if the first and second image data were collected by one or two satellites on the same orbit around the Earth with substantially similar look angles:
applying interferometric analysis to the first and second image data to determine one or more properties of the dry-bulk stockpile based on the interferometric analysis.

4. The method according to claim 3, wherein applying interferometric analysis comprises:
combining the first and second image data to generate an interferogram of an interferometry area,
wherein the interferometry area includes the dry-bulk stockpile and is defined by an overlap between the first and second area.

5. The method according to claim 4, wherein applying interferometric analysis comprises determining a plurality of contours of the dry-bulk stockpile, wherein each of the plurality of contours corresponds to a different elevation of the dry-bulk stockpile.

6. The method according to claim 4, wherein applying interferometric analysis comprises unwrapping a phase in the interferogram to generate an elevation model of the interferometry area.

7. The method according to claim 3, the method further comprising, before applying interferometric analysis:
determining a degree of coherence between the first and second image data; and
verifying that the degree of coherence exceeds a predetermined coherence threshold, wherein the interferometric analysis is only applied if the degree of coherence exceeds the coherence threshold.

8. The method according to claim 3, the method further comprising:
determining a parallax angle between a first line of sight from the satellite that collected the first image data to the dry-bulk stockpile and a second line of sight from the satellite that collected the second image data to the dry-bulk stockpile; and
if the first and second image data were collected by two satellites on different orbits with different look angles:
verifying that the parallax angle is within a predetermined range, wherein the radargrammetric analysis is only applied if the parallax angle is within the predetermined range; or
if the first and second image data were collected by one or two satellites on the same orbit around the Earth with substantially similar look angles:
verifying that the parallax angle is lower than a predetermined threshold, wherein the interferometric analysis is only applied if the parallax angle is lower than the predetermined threshold.

9. The method according to claim 1, wherein applying radargrammetric analysis comprises determining an elevation model of a radargrammetry area based on:
a comparison between the first image data and the second image data; and
a parallax angle between a first line of sight from the satellite that collected the first image data to the dry-bulk stockpile, and a second line of sight from the satellite that collected the second image data to the dry-bulk stockpile,
wherein the radargrammetry area includes the dry-bulk stockpile and is defined by an overlap between the first and second areas.

10. (canceled)

11. (canceled)

12. The method according to claim 1, wherein applying radargrammetric analysis comprises determining a plurality of contours of the dry-bulk stockpile, wherein each of the plurality of contours corresponds to a different elevation of the dry-bulk stockpile, the determined contours are equally spaced across the elevation of the dry-bulk stockpile, and the one or more properties of the dry-bulk stockpile are determined based on the plurality of contours.

13. The method according to claim 12, wherein the one or more properties includes a volume of the dry-bulk stockpile, and determining the volume of the dry-bulk stockpile comprises:
determining a respective surface area of an uppermost contour and a lowermost contour;
interpolating a model outline of the dry-bulk stockpile between the uppermost contour and the lowermost contour; and
determining the volume based on the model outline of the dry-bulk stockpile.

14. The method according to claim 13, further comprising:
determining a respective surface area of each of the contours between the uppermost and the lowermost contour,
wherein interpolating the model outline comprises interpolating the model outline of the dry-bulk stockpile between each pair of neighbouring contours.

15. The method according to claim 1, wherein applying radargrammetric analysis comprises:
generating a position model comprising information indicative of a relative position of each of the satellites used to collect the first and second image data relative to the dry-bulk stockpile at a time at which the first and second image data were respectively collected,
wherein the determination of the one or more properties of the dry-bulk stockpile is based on the position model.

16. The method according to claim 1, wherein applying radargrammetric analysis comprises: identifying one or more matching points in the first and second image data, and extrapolating an elevation model of the dry-bulk stockpile based on the one or more matching points.

17. The method according to claim 1, wherein the first and second image data correspond to synthetic aperture radar images imaged in a slant range, and the method further comprises: transforming the first and second image data to correspond to synthetic aperture radar images in a ground range.

18. (canceled)

19. The method according to claim 1, wherein the determination of one or more properties of the dry-bulk stockpile comprises comparing the-results of the determination with previous results of a previous determination to determine a change in the one or more properties and wherein each of the first and second areas include a plurality of dry-bulk stockpiles, and the method further comprises:
identifying each of the plurality of dry-bulk stockpiles in each of the first and second image data; and
applying the method of any preceding claim to each of the identified dry-bulk stockpiles.

20. The method according to claim 1, wherein the one or more properties includes one or more of:
a volume of the dry-bulk stockpile;
a surface area of the dry-bulk stockpile;
a relative height of the dry-bulk stockpile;
a height of the dry-bulk stockpile; and
a mass of the dry-bulk stockpile.

21. The method according to claim 1, the first and/or second image data are collected by a satellite configured to carry out synthetic aperture radar imaging, and optionally synthetic aperture radar imaging operating in an X-band radar range.

22. A method of monitoring a dry-bulk stockpile, the method comprising:
receiving image data corresponding to at least two images collected by one or more satellites,
wherein each of the one or more images is an image of a dry-bulk stockpile viewed from a different look angle;
determining a respective height of each of a plurality of points on the dry-bulk stockpile based on the received image data; and
determining a volume of the dry-bulk stockpile based on the determined heights of the plurality of points on the dry-bulk stockpile.

23. A data processing apparatus comprising a processor configured to perform the method of claim 1.

24. (canceled)

25. (canceled)
